(19) United States
(12) Patent Application Publication
(10) Pub. No.: US 2021/0204722 A1
(43) Pub. Date: Jul. 8, 2021

(54) Travel Kit

(71) Applicant: SeatSational, LLC, Rochester, MI (US)

(72) Inventor: Gina M. Hoensheid, Rochester, MI (US)

(73) Assignee: SeatSational, LLC, Rochester, MI (US)

(21) Appl. No.: 17/212,779

(22) Filed: Mar. 25, 2021

Related U.S. Application Data
(63) Continuation of application No. 16/285,704, filed on Feb. 26, 2019.
(60) Provisional application No. 62/635,820, filed on Feb. 27, 2018.

(51) Int. Cl. A47C 31/11; A47G 11/00; A41D 13/11; A44C 3/00; B60N 2/60

(52) U.S. Cl. CPC A47C 31/11; A47G 11/003; B60N 2/60; A44C 3/001; A41D 13/11

(57) ABSTRACT

A travel kit for providing a clean and sanitary environment when using public transportation. The travel kit may comprise a seat cover having flexible properties and that is puncture- and abrasion-resistant. The seat cover may be removably disposed over a seat to provide a barrier between the seat and an individual sitting in the seat. The travel kit may also comprise a table cover configured to provide a sanitary working surface. The table cover may also include a retaining feature, such as an adhesive, for removably securing the table cover to a surface. The travel kit may further comprise an entertainment item, such as a writing utensil, configured to write on the table cover. The travel kit may also include a mask, such as a surgical mask, to prevent inhalation of allergens or other microorganisms. The travel kit may include a portable container for storing the contents of the kit.

### RELATED APPLICATIONS

The present application is a continuation of U.S. patent application Ser. No. 16/285,704, filed on Feb. 26, 2019, and claims priority to and all the benefits of U.S. Provisional Patent Application No. 62/635,820, filed on Feb. 27, 2018, which are hereby expressly incorporated herein by reference in their entirety.

### TECHNICAL FIELD

The invention described below relates to a travel kit. More specifically, but not exclusively, the invention relates to a travel kit comprising a seating kit including a seat cover and table cover that can be used in airplanes, stadium seating and the like. Even more specifically, but not exclusively, the invention relates to a travel kit comprising a seating kit including a seat cover including a promotional feature and a health feature.

### BACKGROUND

When out in public, such as attending a public event or utilizing public transportation, an individual may be exposed to varying levels of germs, allergens, and similar contagions that are carried by other individuals and/or present in the environment. For example, when traveling on a plane or attending a stadium for a sporting event, the individual may be exposed to germs or allergens that are present on the seat and/or surrounding environment. There remains a need in the art for a travel kit configured to assist in limiting the individual's exposure to such germs, allergens, and similar contagions.

### SUMMARY

The present disclosure relates generally to a travel kit and method of assembling the travel kit. The travel kit may comprise any combination of a seat cover, a table cover, a mask, a cloth wipe, an entertainment item and/or an indicator.

A travel kit for use by an individual is disclosed, the travel kit comprising a seat cover configured to be removably disposed over a seat to create a sterile barrier between the seat and the individual. The travel kit may further comprise a table cover configured to be removably disposed over a table to create a sanitary working surface. The travel kit may also comprise a mask comprising a filter portion, the mask configured to be at least partially disposed over the face of the individual and to filter microorganisms and/or other allergens from the air as the individual breathes. The travel kit may further comprise a sanitary wipe for sanitizing the individual and/or the environment.

The travel kit may further comprise an entertainment item, wherein the entertainment item comprises at least one chosen from a crayon, a marker, a pencil, a piece of chalk, a pad of paper, and a chalkboard. The travel kit may also comprise an indicator, wherein the indicator is configured to identify a medical condition of the individual.

The seat cover and the table cover of the travel kit may comprise a non-woven fabric that is washable, such that either of the seat cover and the table cover may be reusable. The seat cover may further comprise an indicium, wherein the indicium is related to advertising and/or marketing.

A travel system for use by an individual is disclosed, the travel system comprising a portable container. A seat cover may be removably disposed within the portable container and configured to be removably disposed over a seat to create a sterile barrier between the seat and the individual. A table cover may also be removably disposed within the portable container, wherein the table cover comprises a retaining feature for removably securing the table cover to the table to create a sanitary working surface. A mask comprising a filter portion may be removably disposed within the portable container. The mask may be configured to be at least partially disposed over the face of the individual and to filter contagions and/or other allergens from the air as the individual breathes. An indicator may be removably disposed within the portable container, wherein the indicator is configured to identify a medical condition of the individual. A sanitary wipe may be removably disposed within the portable container, wherein the sanitary wipe comprise an antibacterial solution configured to remove germs and other contagions disposed on the individual and/or within the environment.

A method of assembling a travel kit for use by an individual within a portable container is disclosed, wherein the method may comprise placing a seat cover within the portable container. The seat cover may be configured to be removably disposed over a seat to define a sanitary barrier between the seat and the individual sitting in the seat. The method may also comprise placing a table cover within the portable container, wherein the table cover comprises a writable portion and is configured to be removably coupled to a surface. The method may further comprise placing a mask within the portable container, wherein the mask comprises a filter portion configured to remove. The method may also comprise placing a sanitary wipe within the portable container.

The method may further comprise the step of placing an entertainment item within the portable container, the entertainment item comprising at least one item chosen from a crayon, a marker, a pencil, a piece of chalk, a pad of paper, and a chalkboard. The method may also comprise the step of placing an indicator within the portable container, the indicator configured to identify a medical condition of the individual. The method may further comprise the step of closing the portable container.

These and other configurations, features, and advantages of the present disclosure will be apparent to those skilled in the art. The present disclosure is not to be limited to or by these configurations, features, and advantages.

### BRIEF DESCRIPTION OF THE DRAWINGS

Referring now to the drawings, exemplary illustrations are shown in detail. The drawings may not necessarily be to scale and certain features may be exaggerated to better illustrate and explain an innovative aspect of the present disclosure. Further, the exemplary illustrations described herein are not intended to be exhaustive or otherwise limiting or restricting to the precise form and configuration shown in the drawings and disclosed in the following detailed description.

Advantages of the present invention will be readily appreciated as the same becomes better understood by reference to the following detailed description when considered in connection with the accompanying drawings, wherein:

FIG. 1 is a perspective view of various items that may be included in a travel kit.

FIG. 2A is a perspective view of a first configuration of a seat cover of the travel kit of FIG. 1, wherein the seat cover is disposed over a seat on an airplane with a table cover on the tray table.

FIG. 2B is a perspective view of a second configuration of a seat cover of the travel kit of FIG. 1, wherein the seat cover is disposed over a stadium seat.

FIG. 3A is a perspective view of the top of a first configuration of a table cover of the travel kit of FIG. 1.

FIG. 3B is a perspective view of the bottom of the first configuration of the table cover of FIG. 3A.

FIG. 4A is a perspective view of the top of a second configuration of a table cover of the travel kit of FIG. 1.

FIG. 4B is a perspective view of the bottom of the second configuration of the table cover of FIG. 4A.

FIG. 5 is a perspective view of a portable container of the travel kit of FIG. 1.

### DETAILED DESCRIPTION

As individuals continue to interact more and more with other individuals and their surroundings, this exposes such individuals to increased amounts of germs, bacteria, contagions, and other similar microorganisms. This can result in the individual becoming infected by and/or further spreading the germs, bacteria, contagions, and other similar microorganisms. Individuals are at a greater likelihood of exposure when out in public, such as using public transportation, attending sporting events, or similar public spectacles. The seating and/or other surfaces of these public surfaces are likely to have germs, bacteria, contagions, and other similar microorganisms present on them. The travel kit described in this disclosure seeks to provide items that will limit the individual's exposure to such germs, bacteria, contagions, and other similar microorganisms while traveling and/or utilizing other public facilities. The travel kit described in detail below may provide various health benefits, promotional/advertising opportunities and entertainment benefits that may be utilized either independently and/or in combination.

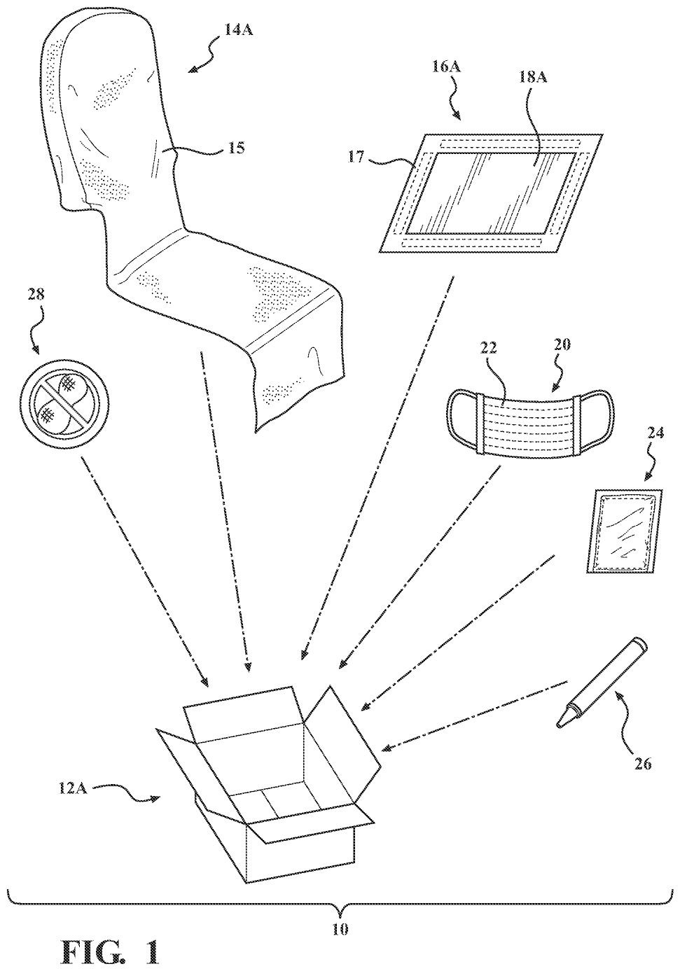

Referring to FIG. 1, an exemplary configuration of a travel kit 10 is illustrated. The travel kit 10 may also be referred to as a seating kit or travel system. The travel kit 10 may comprise any combination of items chosen from the following items: a portable container 12A, a seat cover 14A, a table cover 16A, a mask 20, cloth 24, an entertainment item 26, and an indicator 28. For example, as illustrated in FIG. 1, the travel kit 10 may comprise the seat cover 14A, the table cover 16A, the mask 20, the cloth 24, the entertainment item 26, and the indicator 28, the seat cover 14A, the table cover 16A, the mask 20, cloth 24, the entertainment item 26, and the indicator 28 configured to be packaged together in the portable container 12A. In another configuration, the travel kit 10 may comprise the seat cover 14A, the table cover 16A, the entertainment item 26, and the indicator 28. In yet another configuration, the travel kit 10 may comprise the seat cover 14A, the table cover 16A, the mask 20, and the cloth 24. In even yet another configuration, the travel kit 10 may comprise the seat cover 14A, the table cover 16A, and the entertainment item 26. While all combinations of the various items of the travel kit are not listed, it is contemplated that the travel kit 10 may comprise any combination of the items. Furthermore, while the travel kit 10 of FIG. 1 comprises a portable container 12A for storing the items, a portable container is not required.

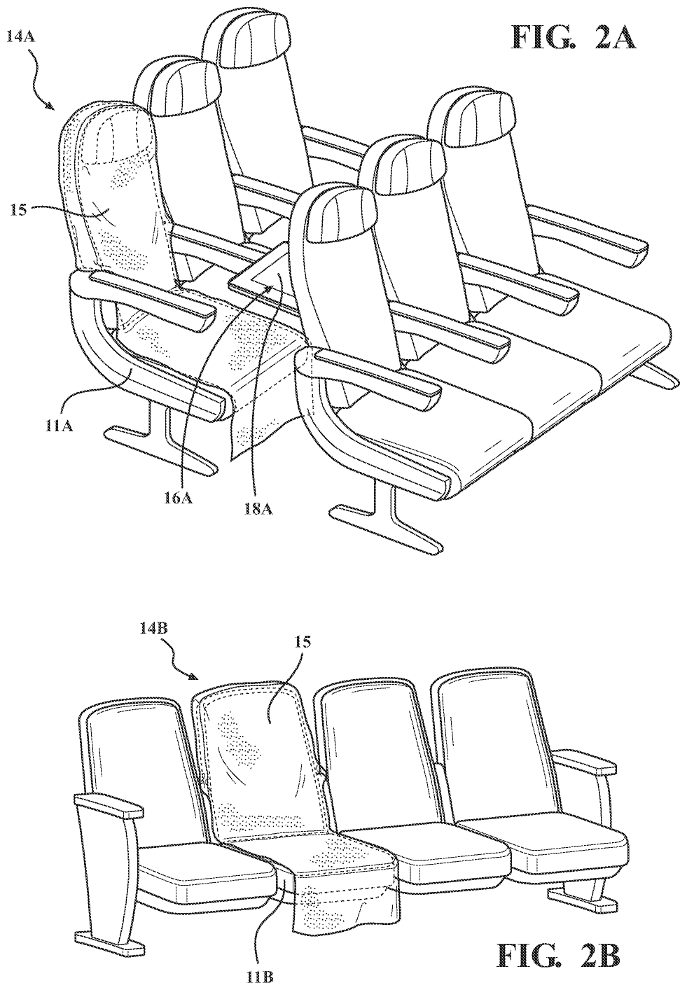

Referring to FIGS. 2A and 2B, exemplary configurations of the seat cover 14A, 14B are illustrated. The seat cover 14A, 14B may be configured to be removably disposed over a seat 11A, 11B to create a sterile barrier between the seat and the individual. For example, a first exemplary configuration of the seat cover 14A may be configured to be disposed over a seat 11A in an airplane, as illustrated in FIG. 2A. A tray cover 16A, 16B, which will; be describe in greater detail below, may also be included as part of the kit 10 to be used with the tray table of the airplane seat 11A. Alternatively, a second exemplary configuration of the seat cover 14B may be configured to be disposed over a stadium seat 11B, as illustrated in FIG. 2B. The seat cover 14A, 14B may comprise a flexible fabric or material 15 that is also puncture- and abrasion-resistant. For example, the seat cover 14A, 14B may comprise a non-woven fabric that is washable. While the exemplary configurations of the seat cover illustrated in FIGS. 2A and 2B, are generally tailored to fit a particular type of seat, it is further contemplated that the seat cover 14A, 14B may be sized and/or shaped to be compatible with various types and/or sizes of seats. The seat cover 14A, 14B cover may be designed to provide multiple sterilization approaches and overall versatility. For example, a single seat cover 14A, 14B may be sized to fit over an airplane seat, a bus seat, and/or a car seat. This may be accomplished by using flexible and/or stretchable fabrics. The seat cover 14A, 14B may also be oversized and provided with a drawstring, flexible cord/strap, or other similar fastening device configured to size and/or secure the seat cover 14A, 14B to the seat. Alternatively, the seat cover 14A may also be adapted to fit over or cover a bench, such as those used in sports arenas.

The seat cover 14A may also comprise an indicia portion 13. The indicia portion 13 may be configured to display marketing and/or advertising material. For example, the indicia portion 13 may comprise an image and/or text that is screen printed directly onto the seat cover 14A. Alternatively, the indicia portion 13 may comprise a pocket, slot, or similar holding apparatus coupled to the seat cover 14A and configured to hold and/or display marketing and/or advertising materials, such as business cards, signs, posters, logos, and the like. The indicia portion 13 may be positioned on the seat cover 14A to provide high visibility for the advertising, marketing, and/or other promotional activities. The indicia portion of the seat cover 14A may be configured to promote a person's name, trademarks, service marks, certification marks, designation (bride, groom, engaged, bride-to-be, groom-to-be, mother of the bride, etc.), or any other visible promotion as desired. It is further contemplated that the indicia portion 13 may also be adapted to provide a surface for entertainment of children or even adults. For example, the indicia portion 13 may comprise a writable surface that works with a pen, marker, chalk, or other similar writing utensil. This may allow the individual to write and/or draw on the indicia portion 13 of the seat cover 14A to pass the time while traveling. It may also provide a writable surface for the individual to use to track stats or events that occur during the sporting event. While the indicia portion 13 is only illustrated on the seat cover 14A in the figures, it is contemplated that the indicia portion 13 may be included on other items in the travel kit 10. For example, the indicia portion 13 may be included on the table cover 16A, 16B, to display a trademark for marketing purposes or to display the user's name. The indicia portion 13 may similarly be included on the mask 20 or the entertainment item 26.

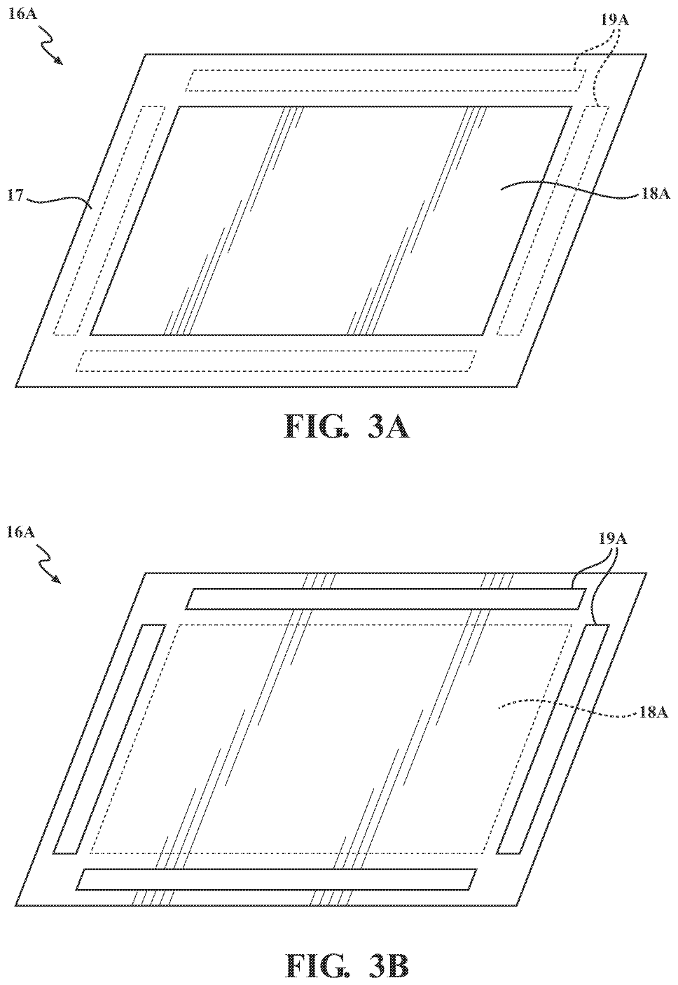

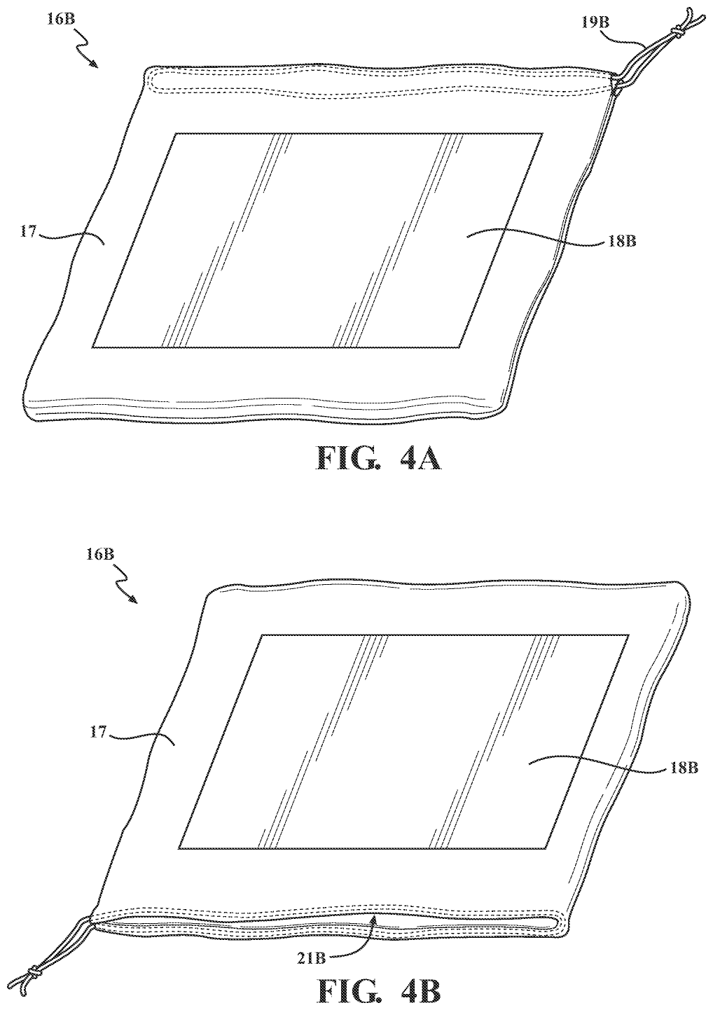

Referring to FIGS. 3A through 4B, exemplary configurations of the table cover 16A, 16B are illustrated. Similar to the seat cover 14A, the table cover 16A, 16B may comprise a flexible fabric or material 17 that is also puncture- and abrasion-resistant. For example, the table cover 16A, 16B may comprise a non-woven fabric that is washable. The table cover 16A, 16B may also comprise a writable portion 18A, 18B. The writable portion 18A, 18B may comprise a board, paper, cardboard, chalkboard or other similar writable surface that is configured to work with a pen, marker, chalk, or other similar writing utensil. The table cover 16A, 16B may be configured to be removably disposed over a table to create a sanitary working surface.

The table cover 16A, 16B may comprise a retaining feature 19A, 19B for removably securing said table cover 16A, 16B to the table. For example, as illustrated in FIGS. 3A and 3B, the table cover 16A may comprise a retaining feature 19A including an adhesive. In the configuration of the table cover 16A illustrated in FIGS. 3A and 3B, the table cover 16A comprises a flat piece of material 17, similar to a place mat, including adhesive strips 19A on the bottom of the table cover 16A for removably securing the table cover 16A to a table or similar surface.

Alternatively, in the configuration of the table cover 16B illustrated in FIGS. 4A and 4B, the material 17 of the table cover 16B may be formed in a pocket-like shape including an opening 21B in at least one end. The opening 21B may allow the table cover 16B to be slid over the top of a tray table, such as those on an airplane. The table cover 16B may also comprise a retaining feature 19B such as a cord, string, or flexible band configured to tie the table cover 16B to the table. Alternatively, the cord, string, or flexible band may be configured to create a friction fit between the table cover 16B and the tray table to secure the table cover 16B to the tray table.

The travel kit 10 may also include the mask 20, such as a surgical mask. The mask 20 may comprise a filter portion 22, the mask 20 configured to be at least partially disposed over the face of the individual and to filter microorganisms and/or other allergens from the air as the individual breathes.

The travel kit 10 may also include the cloth 24. The cloth 24 may comprise a sanitary wipe, conventional cleansing pads, sponges or the like for sanitizing the individual and/or the surrounding environment. For example, the cloth 24 may comprise a sanitary wipe for cleaning the individual's hands. Alternatively, the cloth 24 may comprise a cleansing pad for wiping down the seat, table, armrest, or similar elements in the public environment.

In addition to the cloth 24, the travel kit 10 may further comprise other cleaning or sterilizing products such as hand sanitizer or a disinfectant spray. This may be used to disinfect the user's hands and/or the surrounding environment.

It is further contemplated that the travel kit 10 may comprise a lotion, scented spray or essential oil. For example, the scented spray may be applied to the individual or the surrounding environment to cover or eliminate an undesirable smell. It is also contemplated that the essential oil may be applied to the mask 20, such as the filter portion 22, to provide a pleasant smell and/or heling effect. The essential oil may also be used as a diffuser to provide a pleasant smell to the surrounding environment.

The travel kit 10 may also include the entertainment item 26. The entertainment item 26 may comprise a crayon, a marker, a pencil, a piece of chalk, a pad of paper, and a chalkboard. Alternatively, the entertainment item 26 may comprise a children's toy, such as a game. For example, the entertainment item 26 may comprise a tic-tac-toe game board and pieces. The entertainment item 26 may also comprise a deck of cards or small handheld game.

The travel kit 10 may also include the indicator 28. The indicator 28 may comprise at least one of a pin, a button, a sticker, and a patch. The indicator 28 may be configured to identify a medical condition of the individual. For example, the indicator 28 may comprise a sticker including a symbol, text, or other markings indicating that the individual has a peanut allergy or other similar medical condition or health issue that the public should be aware of in the event of an emergency on an airplane or in a stadium seat. Other examples of allergies that the indicator 28 may be used to identify about the user include dairy free, soy free, gluten free, and/or shellfish free allergies.

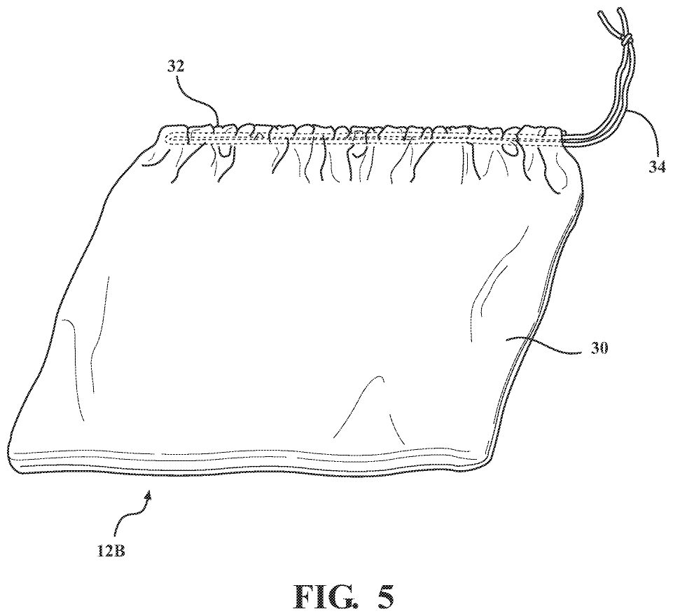

Referring to FIG. 5, an exemplary configuration of the portable container 12B is illustrated. The portable container 12B may comprise a pouch 30 or purse-like container for storing the items of the travel kit 10. The portable container 12B may comprise a zipper 32, adhesive, snaps, buttons, or similar feature configured to seal/close the pouch 30. The travel container may also comprise a handle 34 or similar strap for carrying the portable container 12B.

Referring back to FIG. 1, the schematic generally illustrates a method assembling the travel kit 10. The method of assembling the travel kit 10 for use by an individual within a portable container 12A, 12B may comprise placing a seat cover 14A within the portable container 12A, 12B, wherein the seat cover 14A may be configured to be removably disposed over a seat to define a sanitary barrier between the seat and the individual sitting in the seat. The method may further comprise placing a table cover 16A, 16B within the portable container 12A, 12B, the table cover 16A, 16B comprising a writable portion and configured to be removably coupled to a surface. The method may further comprise placing a mask 20 within the portable container 12A, 12B, wherein the mask 20 comprises a filter portion 22 configured to remove microorganisms and/or other allergens from the air as the individual breathes, and placing a cloth 24 within the portable container 12A, 12B.

The method may further comprise the step of placing an entertainment item 26 within the portable container 12A, 12B, wherein the entertainment item 26 may comprise a crayon, a marker, a pencil, a piece of chalk, a pad of paper, and a chalkboard. The method may also comprise the step of placing an indicator 28 within the portable container 12A, 12B, the indicator 28 configured to identify a medical condition of the individual. The method may also comprise the step of closing the portable container 12A, 12B.

While born out of a desire to fill a need for clean, healthy, and convenient travel, the travel kit 10 may be utilized in any public place where someone would want a clean, fresh seat or workspace every time. This may include stadium seating, restaurant seating, or banquet hall or club seating. Stadium seating, for example, has become more uniform as stadiums purchase seating from similar vendors, allowing for a single seat cover 14A to be utilized across multiple venues and/or stadiums. Another advantage of the disclosed travel kit 10 is that it provides customized packaging that allows for storage of the entire contents of the travel kit 10 in a small and sleek package that can be easily packed and/or transported. The present disclosure permits all of the above advantages in a compact travel kit 10 for potential transportation by the airplane passenger or the stadium audience.

In addition, the travel kit 10 may provide promotional opportunities when each travel kit 10 is sold or otherwise used. For example, a company could order a large number of the travel kits 10 and have them customized with their logo or other promotional materials. The company may then give the customized travel kits 10 away to employees and/or clients. When the travel kits 10 are then used, the company's logo and/or promotional materials are likely to be seen by others. This is in addition to the health benefits provided by the travel kit 10 that are described above, including protection against various bacteria and other potential health risks from various people sitting in a seat, including such things as fecal matter, viruses, bacteria, fungi, and other residue.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A travel kit for use by an individual, said travel kit comprising:
a seat cover configured to fit conformably to and be removably disposed over a transportation seat having a top end and a bottom end to create a sterile barrier from the top end to the bottom end between the seat and the individual transported in said seat;
a table cover configured to be removably disposed over a table associated with said transportation seat to create a sanitary working surface associated with said transportation seat;
a mask comprising a filter portion, said mask configured to be at least partially disposed over the face of the individual transported in said seat and to filter microorganisms and/or other allergens from the air as the individual breathes;
a sanitary wipe for sanitizing the individual and/or the environment surrounding the transportation seat; and
an entertainment item comprising at least one chosen from a crayon, a marker, a pencil, a piece of chalk, a pad of paper, or a chalkboard.

2. The travel kit of claim 1, wherein said table cover comprises a writable portion such that said entertainment item may be used to write on said writable portion of said table cover.

3. The travel kit of claim 1, wherein said table cover comprises a tray table cover that is configured to be removably secured to the surface of a tray table.

4. The travel kit of claim 1, wherein said table cover comprises a retaining feature for removably securing said table cover to the table.

5. The travel kit of claim 4, wherein said retaining feature comprises an adhesive.

6. The travel kit of claim 4, wherein said retaining feature comprises a cord configured to tie said table cover to the table.

7. The travel kit of claim 1, wherein said seat cover further comprises an indicia portion for displaying advertising information.

8. The travel kit of claim 1, further comprising an indicator, said indicator configured to identify a medical condition of the individual.

9. The travel kit of claim 8, wherein said indicator comprises at least one chosen from a pin, a button, a sticker, and a patch.

10. The travel kit of claim 1, wherein said seat cover and said table cover comprise a non-woven fabric that is washable, such that either of said seat cover and said table cover may be reusable.

11. A travel system for use by an individual, said travel system comprising:
a portable container;
a seat cover removably disposed within said portable container and configured to be removably disposed over a transportation seat having a top portion to support the head and neck area of an individual and a bottom portion to provide support to at least the upper legs of an individual to create a sterile barrier between the seat and the individual;
a table cover removably disposed within said portable container, said table cover comprising a retaining feature for removably securing said table cover to a table associated with said transportation seat to create a sanitary working surface;
a mask comprising a filter portion, said mask removably disposed within said portable container and configured to be at least partially disposed over the face of the individual in the transportation seat and to filter microorganisms and/or other allergens from the air as the individual breathes;
an indicator removably disposed within said portable container, said indicator configured to identify a medical condition of the individual to the transportation staff and other persons associated with the seat; and
a sanitary wipe removably disposed within said portable container, said sanitary wipe comprising an antibacterial solution configured to remove germs disposed on the individual or within the environment.

12. The travel system of claim 11, further comprising an entertainment item,
wherein said entertainment item comprises at least one chosen from a crayon, a marker, a pencil, a piece of chalk, a pad of paper, and a chalkboard.

13. The travel system of claim 12, wherein said table cover comprises a writable portion such that said entertainment item may be used to write on said writable portion of said table cover.

14. The travel system of claim 11, wherein said seat cover and said table cover comprise a non-woven fabric that is washable, such that either of said seat cover and said table cover may be reusable.

15. A method of assembling a travel kit for use by an individual within a portable container, said method comprising:
placing a seat cover within the portable container, the seat cover configured to be removably disposed over a transportation seat having a top end and a bottom end to define a sanitary barrier between the seat and the individual sitting in the seat;
placing a table cover within the portable container, the table cover comprising a writable portion and configured to be removably coupled to a surface of a table associated with the transportation seat;
placing a mask within the portable container, the mask comprising a filter portion configured to remove microorganisms and/or other allergens from the air as the individual breathes; and
placing a sanitary wipe within the portable container.

16. The method of claim 15, further comprising the step of placing an entertainment item within the portable container, the entertainment item comprising at least one item chosen from a crayon, a marker, a pencil, a piece of chalk, a pad of paper, and a chalkboard.

17. The method of claim 15, further comprising the step of placing an indicator within the portable container, the indicator configured to identify a medical condition of the individual to at least the staff of the transportation vehicle in which the transportation seat is disposed.

18. The method of claim 15, further comprising the step of closing the portable container.
